(19) United States
(12) Patent Application Publication
(10) Pub. No.: US 2007/0198729 A1
(43) Pub. Date: Aug. 23, 2007

(54) SQL network gadget

(76) Inventor: Sitaramarao Srinivas Yechuri, Las Vegas, NV (US)

Correspondence Address: Sitaramarao Srinivas Yechuri, P.O. Box 193, Lake Forest, CA, 92609, US

(21) Appl. No.: 11/349,434

(22) Filed: Feb. 7, 2006

(51) Int. Cl. G06F 15/16

(52) U.S. Cl. 709/230

(57) ABSTRACT

This invention describes a SQL Network Gadget which can be connected to a computer network. This invention does not use a microprocessor, it does not use an operating system and it does not run software. Devices in the network make a connection to the invention and send encrypted packets which contain SQL queries which are interpreted and a reply is sent back to the device which sent the SQL queries. The data that needs to be stored due to processing the SQL queries is stored on a hard drive which is connected directly to this invention. By removing the overhead of the operating system and removing the interpreting of the software by a general purpose microprocessor, there is both an increase in speed and a reduction in cost.

### TECHNICAL FIELD OF THE INVENTION

This invention relates generally to the storage and access of information using a database management system (DBMS) connected in a computer network.

### BACKGROUND ART

In U.S. Pat. No. 5,850,550 Li, et al. describe a system and method for translating source code, comprising high level source code with embedded SQL statements, to p-code or machine-language instructions by a one-pass parsing mechanism. This is different from the present invention because it is software executed in a computer.

In U.S. Pat. No. 5,881,232 Cheng, et al. describe a method, apparatus, and article of manufacture s for providing access to information stored in a database management system This is different from the present invention because it is software executed in a computer.

In U.S. Pat. No. 6,003,026 Bonzi; Rodolfo et al. describes a method and means for porting an existing application (An) using a relational-database with SQL interface toward a hardware platform (HW2) with a reduced software configuration which does not include an SQL relational-database This is different from the present invention because it is software executed in a computer.

In U.S. Pat. No. 6,063,133 Li, et al. describe a system and method for translating source code, comprising high level source code with embedded SQL statements, to p-code or machine-language instructions by a one-pass parsing mechanism. This is different from the present invention because it is software executed in a computer.

In U.S. Pat. No. 6,151,602 Hejlsberg, et al. describe a three-tier data processing system of the present invention includes a client application, operating on a client machine (i.e., first tier), which obtains data from a back-end data source (e.g., database server) by submitting a request (e.g., SQL query) to a middle tier. This is different from the present invention because it is software executed in a computer.

In U.S. Pat. No. 6,188,783 Balaban et al. describe systems and method for organizing information relating to the design of polymer probe array chips including oligonucleotide array chips. This is different from the present invention because it is a method of organizing information about a chip and it is not itself hardware.

In U.S. Pat. No. 6,341,288 Yach, et al. describe an “UltraLite” database development environment capable of creating a database application that is more portable across multiple devices, including ones having limited computational power. This is different from the present invention because it is software executed in a computer.

In U.S. Pat. No. 6,389,464 Krishnamurthy, et al. describe a device management system. It consists of a site server to which devices to be managed are connected. The site server is configurable from remote locations using Internet browser technology. The site server ports can be -configured as serial ports, contact closure ports and analog ports. Users from remote locations can communicate with the site server via direct dial through a public switch telephone network, as well as Internet and intranet connections. In addition to a modem and a 10-BaseT Ethernet interface, the site server is provided with a manager agent, a MIB or similar data structure of managed objects and/or variables, a Web server, a SQL database engine, TCP/IP routing software, PPP communications support, device-translation drivers and a multi-tasking Device Management Operating System to allow the site server to map native device interfaces into operations to communicate with a manager. This is different from the present invention because it is software executed in a computer.

In U.S. Pat. No. 6,834,309 Leung; Kwok-Yan describes a socket tool embodied in form of coded codes and executed in a computer for its inside application software to “call” to connect and communicate with that of another computer, wherein the socket tool comprises a set of Socket control codes for TCP network connection basing on the Transmission Control Protocol (TCP) and a value-incremental code for dealing with data to be transmitted by the application layer software. This is different from the present invention because it is software executed in a computer.

### SUMMARY OF THE INVENTION

In this invention a low cost SQL server is described. A single chip is described which can be connected to the internet network and accepts SQL queries, processes them and sends back the response. In it's simplest embodiment, all the database information i.e. the data used in the SQL transactions is stored on chip. In successively more complex embodiments the database information is stored in DRAM outside this chip, or in non volatile memory outside this chip or in a hard disk drive attached to this chip. Similarly the simplest embodiment does not use any encryption to encrypt or decrypt the packets whereas more complex embodiments use encryption to protect the data.

### BEST MODE FOR CARRYING OUT THE INVENTION

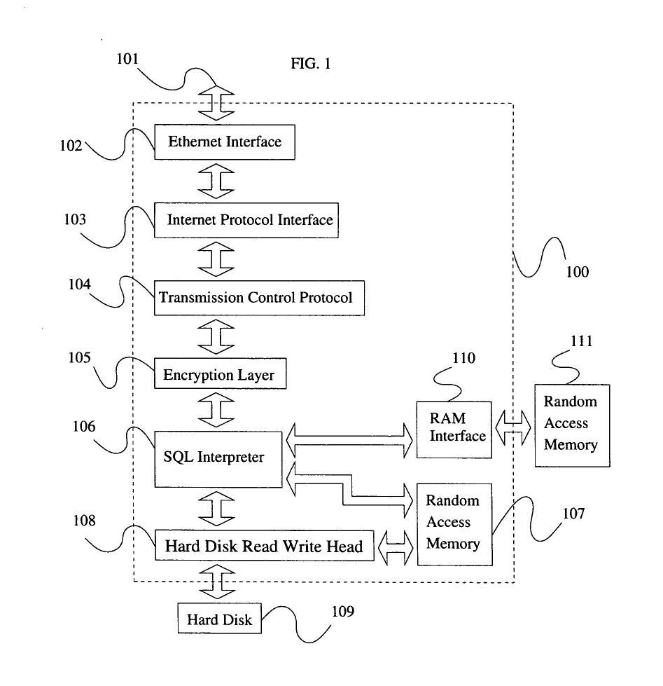

In FIG. 1, an integrated circuit chip 100 is shown. The input/output to the chip are 101 and these inputs are accepted by the Ethernet Interface 102 which allows this invention to be connected to the internet network. This interface 102 implements the ethernet protocol, but alternately the interface 102 may not be ethernet protocol but can be a different protocol such as the token ring protocol. The data is then passed to and from the Internet Protocol (IP) Interface 103 which implements the Internet Protocol.

The interface 103 passes data back and forth to the Transmission Control Protocol (TCP) interface 104 which implements the Transmission Control Protocol. In this way other devices on the internet network can establish a TCP/IP connection with the invention via the input/output connection 101, the Ethernet Interface 102, the Internet Protocol Interface 103 and the Transmission Control Protocol interface 104. Alternately the interface 104 can be the Universal Datagram Protocol (UDP) in which case the other devices on the internet network can exchange UDP/IP packets with the invention.

The interface 104 passes the data in the incoming packet to the Encryption Layer 105 and accepts the outgoing data from the Encryption Layer 105 in order to send a packet onto the network via the Internet Protocol Interface 103. The Encryption Layer 105 performs encryption and decryption of the data for security purposes. The encryption can be a standard such as Rivest-Shamir-Adleman (RSA) or any other encryption standard. The incoming data decrypted in the Encryption Layer 105 is passed to the SQL Interpreter 106 which executes the SQL statements in the incoming data. When SQL statements are executed data could be retrieved, modified or saved. The location where this data is retrieved from, modified or stored in is the Random Access Memory 107.

In order to save the data of the SQL Interpreter 106 in a permanent form which is not lost when the electricity is turned off, the data of the SQL Interpreter 106 is passed to the Hard Disk Read Write Head 108 which in turn directly controls the writing and reading from the Hard Disk 109. So in fact the integrated circuit chip 100 can be mounted directly within the hard disk enclosure to allow the Hard Disk Read Write Head 108 to interact with the hard disk. Alternately the Hard Disk Read Write Head 108 can simply implement a standard disk drive bus standard such as the Small Computer System Interface (SCSI) or the Advanced Technology Attachment (ATA) standard to communicate with the Hard Disk 109. In this case the Hard Disk 109 will be a standard Hard Disk Drive available on the commercial market, which has it's own Read Write Head and a SCSI or ATA or similar interface.

Alternately the data parsed by the SQL Interpreter 106 could be given to a RAM interface 110 which interacts with external Random Access Memory 111 located outside the integrated circuit chip 100. This Random Access Memory 111 may be either volatile or non-volatile.

What is claimed is:

1. An integrated circuit which can be connected to the internet comprising:
a primary interface which implements a network protocol such as the ethernet protocol
a second interface which implements the internet protocol and which interacts with the primary interface
a third interface which implements the transmission control protocol and which interacts with the second interface
a fourth interface which implements a standard encryption algorithm such as RSA encryption and which interacts with the third interface
a fifth interface which interprets the SQL language and which interacts with the fourth interface

2. The integrated circuit of claim 1 additionally comprising:
a sixth interface which reads and writes an external hard disk drive and which interacts with the fifth interface

3. The integrated circuit of claim 1 additionally comprising:
a seventh interface which reads and writes an external random access memory and which interacts with the fifth interface

4. The claim of 3 wherein the external random access memory is non-volatile

5. The integrated circuit of claim 1 where the third interface implements the universal datagram protocol instead of the transmission control protocol

6. The integrated circuit of claim 1 where the fourth interface is absent and the fifth interface interacts directly with the third interface
